(19) United States
(12) Patent Application Publication
(10) Pub. No.: US 2026/0340346 A1
(43) Pub. Date: Oct. 29, 2026

(54) INFORMATION PROCESSING SYSTEM, INFORMATION PROCESSING METHOD, AND PROGRAM

(71) Applicant: Preferred Networks, Inc., Tokyo (JP)

(72) Inventor: Kazuki MATOYA, Tokyo (JP)

(21) Appl. No.: 19/699,461

(22) Filed: Jun. 5, 2026

Related U.S. Application Data
(63) Continuation of application No. PCT/JP2025/034436, filed on Sep. 29, 2025.

(30) Foreign Application Priority Data
Oct. 2, 2024 (JP) 2024-173485

(51) Int. Cl. G06N 3/045; G06N 3/10

(52) U.S. Cl. CPC G06N 3/045; G06N 3/10

(57) ABSTRACT

An information processing system includes at least one first memory; at least one first processor connected to the at least one first memory; at least one second memory; and at least one second processor connected to the at least one second memory. The first processor is configured to generate intermediate data by inputting input information into a machine learning model. The second processor is configured to generate output information of the machine learning model, using at least a portion of the intermediate data generated by the first processor. A ratio of a data transfer speed of the first memory to a computational speed of the first processor is lower than a ratio of a data transfer speed of the second memory to a computational speed of the second processor. The first processor and the second processor are different types of processors.

### CROSS-REFERENCE TO RELATED APPLICATIONS

This application is a continuation application of International Application No. PCT/JP2025/034436 filed on Sep. 29, 2025, and designating the U.S., which is based upon and claims priority to Japanese Patent Application No. 2024-173485 filed on Oct. 2, 2024, the entire contents of which are incorporated herein by reference.

### BACKGROUND

### 1. Technical Field

The present disclosure relates to an information processing system, an information processing method, and a program.

### 2. Description of the Related Art

Machine learning models such as Large Language Models (LLMs) are known. To efficiently perform inference processes on large language models, there is a technique for generating intermediate data called key-value caches.

### RELATED ART DOCUMENT

### Non-patent Document

[Non-patent document 1] Insu Jang, “LLM Inference: Continuous Batching and PagedAttention”, [online], [retrieved Aug. 29, 2024]

### SUMMARY

An information processing system according to one aspect of the present disclosure includes at least one first memory; at least one first processor connected to the at least one first memory; at least one second memory; and at least one second processor connected to the at least one second memory. The at least one first processor is configured to generate intermediate data by inputting input information into a machine learning model. The at least one second processor is configured to generate output information of the machine learning model, using at least a portion of the intermediate data generated by the at least one first processor. A ratio of a data transfer speed of the at least one first memory to a computational speed of the at least one first processor is lower than a ratio of a data transfer speed of the at least one second memory to a computational speed of the at least one second processor. The at least one first processor and the at least one second processor are different types of processors.

### BRIEF DESCRIPTION OF THE DRAWINGS

FIG. 1 is a diagram for explaining an example of an inference process of a machine learning model;

FIG. 2 is a block diagram illustrating a first example of an overall configuration of an information processing system;

FIG. 3 is a block diagram illustrating a second example of the overall configuration of the information processing system;

FIG. 4 is a block diagram illustrating a third example of the overall configuration of the information processing system;

FIG. 5 is a flowchart illustrating an example of the inference process of the machine learning model; and

FIG. 6 is a block diagram illustrating an example of a hardware configuration of a computer.

### DETAILED DESCRIPTION

Hereinafter, embodiments of the present disclosure will be described with reference to the accompanying drawings. Here, in the present specification and the drawings, components having substantially the same functional configuration are denoted by the same reference numerals and duplicated descriptions thereof will be omitted.

### First Embodiment

A first embodiment of the present disclosure is an example of an information processing system configured to perform a predetermined task based on a machine learning model. In the present embodiment, the machine learning model may include a neural network having an attention mechanism. The neural network having the attention mechanism may be a neural network that is also called a transformer or the like, for example.

The machine learning model is not limited to a transformer. The machine learning model may be a state space model (SSM), for example. The machine learning model may include a plurality of machine learning models. The machine learning model may include, for example, mamba and jamba. The machine learning model may be any model as long as it generates intermediate data in an inference process.

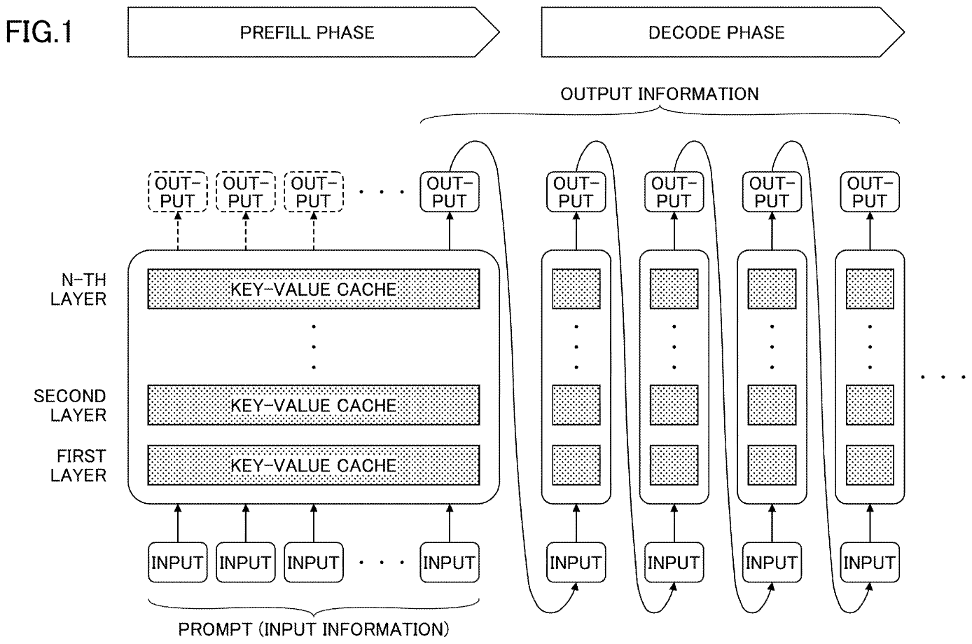

An inference process of a transformer, which is an example of the machine learning model, will be described with reference to FIG. 1. FIG. 1 is a diagram for explaining an example of the inference process of the machine learning model.

As illustrated in FIG. 1, the inference process of a transformer can be broadly divided into a prefill phase and a decode phase. The prefill phase generates a key-value cache based on input information called a prompt. The decode phase generates output information using the key-value cache generated in the prefill phase. The prefill phase is an example of a first process. The decode phase is an example of a second process.

In the prefill phase, the input prompt is divided into tokens and input into the transformer one by one from the beginning. The transformer performs forward processing for each of the input tokens. In the forward processing, the transformer calculates a query vector, a key vector, and a value vector for each of the tokens. The transformer outputs one token for each of the input tokens.

The transformer caches an array of the key vector and the value vector calculated for each of the tokens. The cached array of the key vector and the value vector is called a key-value cache. The key-value cache is generated for each of the layers constituting the transformer. The key-value cache of each of the layers is sequentially calculated from a layer closer to an input layer toward the output layer. In the example of FIG. 1, the transformer includes N hidden layers, and the key-value cache is sequentially generated from the first layer to the N-th layer.

Here, the token is a unit of processing when a machine learning model processes electronic data, and the amount of data in one token may vary depending on the design of the machine learning model. The token is, for example, one Japanese character or one English word, but one character may be represented by two tokens or two or more characters may be represented by one token depending on the frequency of appearance.

The cache is, for example, a technique for replicating, to a high-speed storage device, data that has been recently read or that is frequently used among data read from a low-speed storage device or the like. The high-speed storage device to which the data is replicated or the replicated data itself may be called a cache. That is, the key-value cache may include a process in which a machine learning model stores key vectors and value vectors, may include stored key vectors and value vectors, and may include a storage area in which key vectors and value vectors are stored.

In the decode phase, the last token output in the prefill phase is input into the transformer. The transformer performs forward processing on the input token, using the key-value cache generated in the prefill phase. The token output in the forward processing is input into the transformer again. The decode phase generates output information for the prompt by repeatedly performing forward processing on the token output in the previous forward processing. That is, the decode phase generates output information for the prompt by performing forward processing autoregressively.

Because the prefill phase has low computational order dependency, forward processing can be performed in parallel for each of the input tokens. In contrast, because the decode phase has high computational order dependency, forward processing must be performed sequentially, and the amount of data to be read from and written to the memory increases. Therefore, performing the decode phase requires more processor memory bandwidth per operation amount than performing the prefill phase. That is, when the prefill phase and the decode phase are performed, it can be said that the prefill phase is compute-bound and the decode phase is memory-bound.

Here, the prefill phase is an example of a first process and the decode phase is an example of a second process. The first process may be a process having a degree of being compute-bound that is relatively greater than that of the second process, and the second process may be a process having a degree of being memory-bound that is relatively greater than that of the first process.

In the related art, the inference process of the machine learning model is performed by the same processor. Here, the same processor includes the use of a plurality of processors of the same type. When the prefill phase and the decode phase are performed by the same processor, memory bandwidth is excessive in the prefill phase, and computational performance is excessive in the decode phase. In other words, when the inference process of the machine learning model is performed by the same processor, the performance of the processor cannot be effectively utilized. Therefore, there is room for improving the efficiency of the inference process of the machine learning model.

The present embodiment provides a technique for generating output information of a machine learning model at high speed. In the present embodiment, an information processing system includes two or more processors having different ratios of data transfer speed to computational speed. A first processor having a relatively low ratio of data transfer speed to computational speed (i.e., high computational performance) generates intermediate data by inputting input information into a machine learning model, and transmits at least a portion of the intermediate data to a second processor. The second processor having a relatively high ratio of data transfer speed to computational speed (i.e., high memory bandwidth) generates output information of the machine learning model by using at least the portion of the intermediate data received from the first processor.

The generation of the intermediate data is compute-bound. Therefore, if a processor having a high computational performance is used, the intermediate data can be generated at high speed. The generation of the output information is memory-bound. Therefore, if a processor having a large memory bandwidth is used, the output information can be generated at high speed. In one aspect, according to the present embodiment, because the performance of the processor can be effectively utilized through the inference process of the machine learning model, the output information of the machine learning model can be generated at high speed.

### <Overall Configuration of Information Processing System>

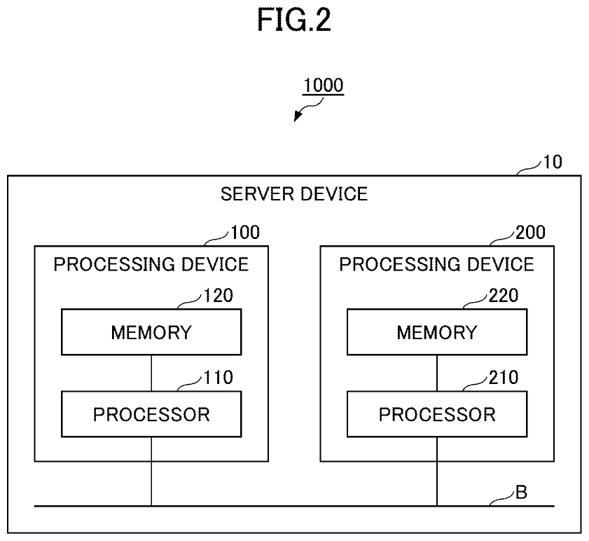

An overall configuration of an information processing system according to the present embodiment will be described with reference to FIGS. 2 to 4.

FIG. 2 is a block diagram illustrating a first example of the overall configuration of the information processing system. As illustrated in FIG. 2, an information processing system 1000 may include one or more server devices 10. The information processing system 1000 may include a plurality of server devices 10.

The server device 10 may include one or more processing devices 100 and one or more processing devices 200. The server device 10 may include a plurality of processing devices 100. The server device 10 may include a plurality of processing devices 200. The number of processing devices 100 included in the server device 10 and the number of processing devices 200 included in the server device 10 may be the same or different.

When the server device 10 includes a plurality of processing devices 100, the plurality of processing devices 100 may form a cluster. The plurality of processing devices 100 forming the cluster may perform parallel processing. The plurality of processing devices 100 may combine data processed in parallel and transmit the combined data to the processing device 200.

The number of processing devices 200 included in the server device 10 may be greater than the number of processing devices 100 included in the server device 10. For example, the server device 10 may include one processing device 100 and a plurality of processing devices 200. When the server device 10 includes a plurality of processing devices 200, the plurality of processing devices 200 may form a cluster. The plurality of processing devices 200 forming the cluster may perform parallel processing. When the server device 10 includes a plurality of processing devices 200, the processing device 100 may transmit the data to each of the plurality of processing devices 200.

The processing device 100 may include one or more processors 110 and one or more memories 120. The processing device 100 may include a plurality of processors 110 and a plurality of memories 120. The processor 110 and the memory 120 may be electrically connected. The processor 110 and the memory 120 may be connected so as to be capable of data communication with each other.

The processing device 200 may include one or more processors 210 and one or more memories 220. The processing device 200 may include a plurality of processors 210 and a plurality of memories 220. The processor 210 and the memory 220 may be electrically connected. The processor 210 and the memory 220 may be connected so as to be capable of data communication with each other.

The processing device 100 and the processing device 200 may be connected to a bus B of the server device 10. The processing device 100 and the processing device 200 may be configured so as to be capable of data communication with each other via the bus B. The bus B may be a dedicated transmission path (interconnect) capable of data communication between the processing device 100 and the processing device 200. The bus B may be a system bus included in the server device 10.

The processing device 100 and the processing device 200 may be devices including a processing circuit configured to perform specific computation at high speed. The processing device 100 and the processing device 200 may be devices including a processing circuit configured to perform general-purpose computation. The specific computation may include, for example, a multiply-accumulate operation or the like that is often used in neural network training.

The processing device 100 and the processing device 200 may be, for example, a graphic processing unit (GPU) package (for example, a GPU board or GPU card) including one or more graphics processing units (GPUs). The processing device 100 and the processing device 200 may be, for example, a central processing unit (CPU) package (for example, a CPU board or a CPU card) including one or more central processing units (CPUs). The processing device 100 and the processing device 200 may include one or more various accelerators.

The processing device 100 and the processing device 200 may be processing devices of the same type or different types. For example, the processing device 100 may include a GPU package or an accelerator, and the processing device 200 may include a CPU package. For example, the processing device 100 may include a first type of GPU package, and the processing device 200 may include a second type of GPU package. For example, the processing device 100 may include a first type of accelerator, and the processing device 200 may include a second type of accelerator.

The memory 120 may be a storage device that stores data used in computation of the processor 110 and data obtained by the computation of the processor 110. The memory 220 may be a storage device for storing data used in computation of the processor 210 and data obtained by the computation of the processor 210. The memory 120 and the memory 220 may be, for example, a dynamic random access memory (DRAM) or a static random access memory (SRAM). The memory 120 and the memory 220 may be, for example, a three-dimensionally structured memory including a large number of stacked layers.

The memory 120 and the memory 220 may store parameters of the machine learning model. The memory 120 and the memory 220 may store at least a portion of the parameters of the machine learning model. The memory 120 and the memory 220 may store all the parameters of the machine learning model. The parameters stored in the memory 120 and the parameters stored in the memory 220 may be the same or different. The memory 120 may store parameters necessary for processing performed by the processor 110. The memory 220 may store parameters necessary for processing performed by the processor 210.

The processing device 100 has a lower B/F ratio (Bytes/FLOPS) than the processing device 200. Conversely, the processing device 200 has a higher B/F ratio than the processing device 100. The B/F ratio is a ratio of the memory bandwidth to the computational performance. The memory bandwidth is an example of an index representing the data transfer speed of the memory. The data transfer speed may be, for example, the amount of data that the processor can read from and write to the memory per unit time. The computational performance is an example of an index representing the computational speed. The computational performance may be, for example, the number of floating-point operations that can be executed by the processor per unit time. The computational performance may vary depending on the precision of the floating-point numbers serving as computation results.

In other words, the ratio of the data transfer speed of the memory 120 to the computational speed of the processor 110 (data transfer speed/computational speed) is lower than the ratio of the data transfer speed of the memory 220 to the computational speed of the processor 210. Conversely, the ratio of the data transfer speed of the memory 220 to the computational speed of the processor 210 is higher than the ratio of the data transfer speed of the memory 120 to the computational speed of the processor 110.

The difference between the B/F ratio of the processing device 100 and the B/F ratio of the processing device 200 is not particularly limited. For example, the difference between the B/F ratio of the processing device 100 and the B/F ratio of the processing device 200 may be about a factor of 10. For example, the B/F ratio of the processing device 100 may be about 1:1000(=0.001 ), and the B/F ratio of the processing device 200 may be about 1:100(=0.01 ).

The data transfer speed of the memory and the computational speed of the processor may be theoretical performance or may be performance when performing a predetermined process. The theoretical performance may be catalog values of the memory and the processor. The predetermined process may include a process related to the machine learning model. For example, the predetermined process may include an inference process of a machine learning model or one or more operations included in the inference process.

The ratio of the data transfer speed to the computational performance may be a value calculated throughout the predetermined process or a value calculated per unit time when performing the predetermined process. In other words, the ratio of the data transfer speed to the computational performance may be a ratio of the total data transfer amount of the entire process related to the machine learning model to the total number of operations of the entire process related to the machine learning model. Additionally, the ratio of the data transfer speed to the computational performance may be a ratio of the data transfer amount per unit time when performing the process related to the machine learning model to the number of operations per unit time when performing the process related to the machine learning model.

The ratio of the data transfer speed to the computational performance may be a value calculated according to a combination of the number of processors and the number of memories used when performing the processing. As a first example, the ratio of the data transfer speed to the computational performance may be a performance when performing the processing using one memory and one processor, or a theoretical performance in this case. As a second example, the ratio of the data transfer speed to the computational performance may be a performance when performing the processing using one memory and two or more processors, or a theoretical performance in this case. As a third example, the ratio of the data transfer speed to the computational performance may be a performance when performing the processing using two or more memories and one processor, or a theoretical performance in this case. As a fourth example, the ratio of the data transfer speed to the computational performance may be a performance when performing the processing using two or more memories and two or more processors, or a theoretical performance in this case.

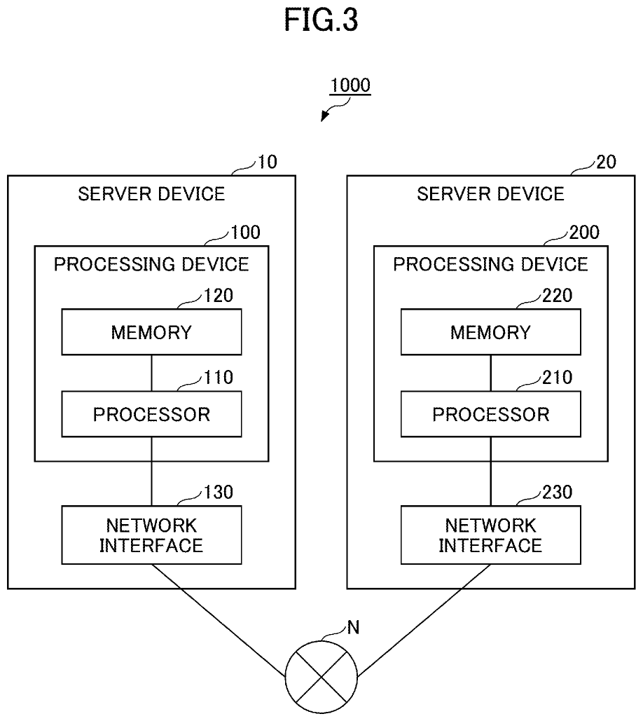

FIG. 3 is a block diagram illustrating a second example of the overall configuration of the information processing system. As illustrated in FIG. 3, the information processing system 1000 may include one or more server devices 10 and one or more server devices 20. The information processing system 1000 may include a plurality of server devices 10. The information processing system 1000 may include a plurality of server devices 20. The number of server devices 10 included in the information processing system 1000 and the number of server devices 20 included in the information processing system 1000 may be the same or different.

The server device 10 may include one or more processing devices 100 and a network interface 130. The server device 10 may include a plurality of processing devices 100. The processing device 100 may be configured in the same manner as in the first example.

The server device 20 may include one or more processing devices 200 and a network interface 230. The server device 20 may include a plurality of processing devices 200. The processing device 200 may be configured in the same manner as in the first example.

The network interface 130 and the network interface 230 may be connected to a communication network N. The processing device 100 and the processing device 200 may be configured so as to be capable of data communication with each other via the communication network N. The communication network N may include a dedicated communication path capable of data communication between the network interface 130 and the network interface 230. The communication network N may be, for example, a communication network, such as a local area network (LAN) or the Internet.

When the information processing system 1000 includes a plurality of server devices 10, the plurality of server devices 10 may form a cluster. The plurality of server devices 10 forming the cluster may perform parallel processing. The plurality of server devices 10 may combine data processed in parallel and transmit the combined data to the server device 20.

The number of server devices 20 may be greater than the number of server devices 10. For example, the information processing system 1000 may include one server device 10 and a plurality of server devices 20. When the information processing system 1000 includes a plurality of server devices 20, the plurality of server devices 20 may form a cluster. The plurality of server devices 20 forming the cluster may perform parallel processing. When the information processing system 1000 includes a plurality of server devices 20, the server device 10 may transmit the data to each of the plurality of server devices 20.

The processing devices 100 and 200 may be configured as in the first example. That is, the processing device 100 included in the server device 10 has a lower B/F ratio (Bytes/FLOPS) than the processing device 200 included in the server device 20. Conversely, the processing device 200 included in the server device 20 has a higher B/F ratio than the processing device 100 included in the server device 10.

In other words, the ratio of the data transfer speed of the memory 120 to the computational speed of the processor 110 (data transfer speed/computational speed) is lower than the ratio of the data transfer speed of the memory 220 to the computational speed of the processor 210. Conversely, the ratio of the data transfer speed of the memory 220 to the computational speed of the processor 210 is higher than the ratio of the data transfer speed of the memory 120 to the computational speed of the processor 110.

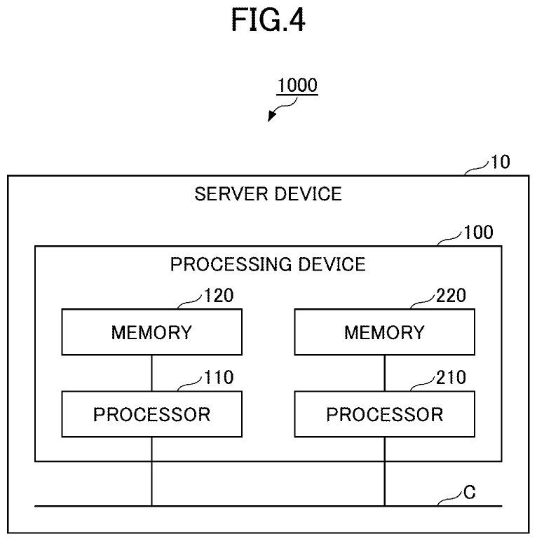

FIG. 4 is a block diagram illustrating a third example of the overall configuration of the information processing system. As illustrated in FIG. 4, the information processing system 1000 may include one or more server devices 10. The information processing system 1000 may include a plurality of server devices 10.

The server device 10 may include one or more processing devices 100. The server device 10 may include a plurality of processing devices 100.

The processing device 100 may include one or more processors 110, one or more processors 210, one or more memories 120, and one or more memories 220. The processing device 100 may include a plurality of processors 110. The processing device 100 may include a plurality of memories 120. The processing device 100 may include a plurality of processors 210. The processing device 100 may include a plurality of memories 220.

The processor 110 and the memory 120 may be electrically connected. The processor 110 and the memory 120 may be connected so as to be capable of data communication with each other. The processor 210 and the memory 220 may be electrically connected. The processor 210 and the memory 220 may be connected so as to be capable of data communication with each other.

The processor 110 and the processor 210 may be connected to a circuit C formed in the processing device 100. The processor 110 and the processor 210 may be configured so as to be capable of data communication with each other via the circuit C. The circuit C may, for example, include an electronic component or wiring formed on a substrate of the processing device 100.

When the processing device 100 includes a plurality of processors 110, the plurality of processors 110 may perform parallel processing. The plurality of processors 110 may combine data processed in parallel and transmit the combined data to the processor 210.

The number of processors 210 may be greater than the number of processors 110. For example, the processing device 100 may include one processor 110 and a plurality of processors 210. When the processing device 100 includes a plurality of processors 210, the plurality of processors 210 may perform parallel processing. When the processing device 100 includes a plurality of processors 210, the processor 110 may transmit the data to each of the plurality of processors 210.

The processor 110, the processor 210, the memory 120, and the memory 220 may be configured in the same manner as in the first example. That is, the ratio of the data transfer speed of the memory 120 to the computational speed of the processor 110 (data transfer speed/computational speed) is lower than the ratio of the data transfer speed of the memory 220 to the computational speed of the processor 210. Conversely, the ratio of the data transfer speed of the memory 220 to the computational speed of the processor 210 is higher than the ratio of the data transfer speed of the memory 120 to the computational speed of the processor 110.

Here, the overall configurations of the information processing system 1000 illustrated in FIGS. 2 to 4 are examples, and there may be various system configuration examples according to applications and purposes. The information processing system 1000 may be configured by one or more devices. The device included in the information processing system 1000 may be a system configured by a plurality of devices. Each function included in the information processing system 1000 may be realized by any device in the system. Each component included in the information processing system 1000 may be included in any device in the system.

### <Flow of Inference Process>

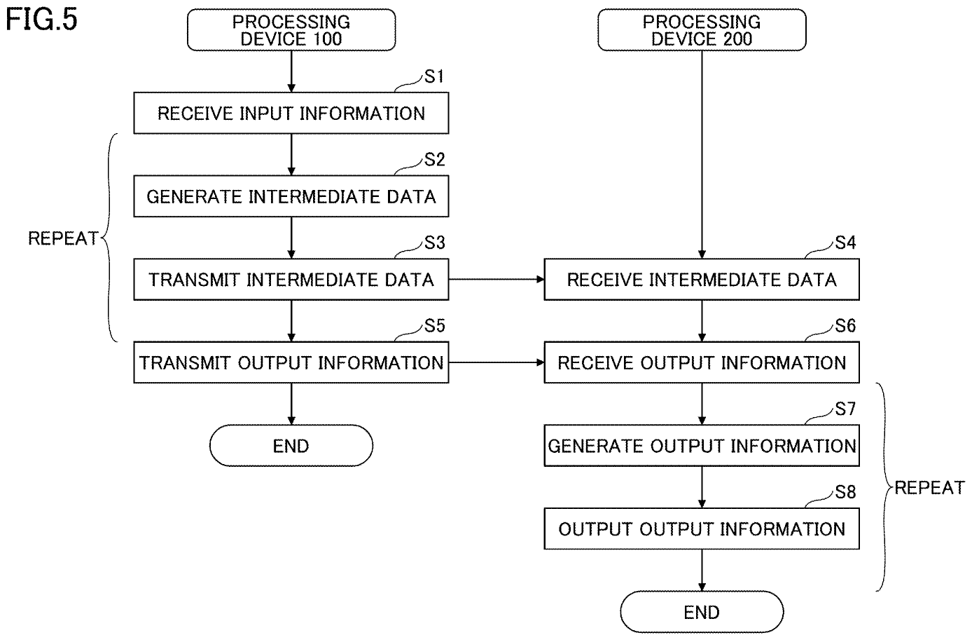

The inference process of the machine learning model executed by the information processing system 1000 will be described with reference to FIG. 5. FIG. 5 is a flowchart illustrating an example of the inference process of the machine learning model. Here, an example in which the information processing system 1000 illustrated in FIG. 2 performs the inference process of the machine learning model will be described.

The information processing system 1000 stores parameters of the machine learning model in the memories 120 and 220 before performing the inference process of the machine learning model. The parameters of the machine learning model stored in the memory 120 may be read from an auxiliary storage device built in the server device 10 or an external storage device connected to the server device 10. The parameters of the machine learning model stored in the memory 220 may be read from an auxiliary storage device built in the server device 20 or an external storage device connected to the server device 20.

In step S1, the processing device 100 receives the input information for the machine learning model. The input information may be, for example, a natural language sentence called a prompt. The input information is not limited to text data. The input information may include at least one of acoustic data or image data. The image data may include a still image and a moving image, and the moving image may include acoustic data. The input information may be multimodal data including at least two of text data, acoustic data, or image data. The input information may be input by a user of the information processing system 1000. The input information may be generated by the information processing system 1000, or an external information processing device or information processing system. Here, “external” indicates not being included in the information processing system 1000.

The processing device 100 may receive, for example, the input information received by the server device 10 from another device. The other device may be a terminal device operated by a user or an external information processing device or information processing system that has generated the input information. For example, the processing device 100 may receive the input information input to the server device 10.

In step S2, the processing device 100 generates the intermediate data based on the input information received in step S1. The processing device 100 may generate the intermediate data by inputting the input information into the machine learning model. When the server device 10 includes a plurality of processing devices 100, the processing devices 100 may generate the intermediate data by parallel processing. The processing device 100 stores the intermediate data generated by the machine learning model in the memory 120.

The processing device 100 may generate a key-value cache, which is an example of the intermediate data, by inputting the prompt, which is an example of the input information, into the transformer, which is an example of the machine learning model. The processing device 100 may generate a state in a state space model, which is an example of the intermediate data, by inputting the prompt, which is an example of the input information, into the state space model, which is an example of the machine learning model. The state in the state space model may be represented by one or more vectors or tensors.

The processing device 100 may perform the prefill phase of the transformer, for example. The processing device 100 may compute an embedded representation, which is another example of the intermediate data, based on the image data included in the input information, as another example.

The transformer performs forward processing for each of the input tokens. The transformer computes a query vector, a key vector, and a value vector for each of the tokens in the forward processing. The transformer caches an array of the key vector and the value vector for each of the tokens. This generates a key-value cache. The transformer sequentially generates the key-value cache from a layer closer to the input layer toward the output layer.

The processing device 100 may read at least a portion of the parameters of the machine learning model stored in the memory 120. The processing device 100 may generate the intermediate data based on at least the portion of the parameters read from the memory 120. The processing device 100 may read at least the portion of the parameters of the machine learning model from the memory 120 each time the processing device 100 performs forward processing on the input token. The processing device 100 may read at least the portion of the parameters of the machine learning model that are related to the input token from the memory 120.

In step S3, the processing device 100 transmits the intermediate data generated in step S2 to the processing device 200. The processing device 100 may read the intermediate data stored in the memory 120 and transmit the intermediate data to the processing device 200 via the bus B. The processing device 100 may transmit at least a portion of the intermediate data to the processing device 200.

The processing device 100 may directly transmit the intermediate data to the processing device 200 (the memory 220). The processing device 100 may indirectly transmit the intermediate data to the processing device 200 (the memory 220). As an example of the transmission process, the processing device 100 may store the intermediate data in a storage device and transmit, to the processing device 200, information capable of identifying the intermediate data stored in the storage device. The storage device for storing the intermediate data may be the memory 120 or another memory. The processing device 200 may acquire the intermediate data stored in the storage device by using the information capable of identifying the intermediate data. Additionally, the processing device 100 may transmit the intermediate data to the memory 220 via another device. That is, the processing device 100 only needs to make the intermediate data available to the processing device 200 by any method.

When the server device 10 includes a plurality of processing devices 100, the processing devices 100 may combine a plurality of pieces of intermediate data stored in a plurality of memories 120 and transmit the combined intermediate data to the processing device 200. When the server device 10 includes a plurality of processing devices 200, the processing device 100 may transmit the intermediate data to each of the plurality of processing devices 200.

The processing device 100 may start transmitting at least a portion of the generated intermediate data to the processing device 200 before the generation of the intermediate data is completed. The processing device 100 may transmit the key-value caches, generated by the transformer on a layer-by-layer basis, to the processing device 200 on a layer-by-layer basis. For example, the processing device 100 may start transmitting the generated key-value cache each time the key-value cache of one layer is generated before the generation of the key-value caches of all layers is completed. As another example, the processing device 100 may start transmitting the key-value caches of all layers after the generation of the key-value caches of all layers is completed.

In step S4, the processing device 200 receives the intermediate data from the processing device 100. The processing device 200 stores the intermediate data received from the processing device 100 in the memory 220.

The information processing system 1000 may repeatedly perform the processing from step S2 to step S4. For example, the processing device 100 may repeatedly perform, for the number of layers of the transformer, generating a key-value cache for each of the layers of the transformer and transmitting the generated key-value cache to the processing device 200 each time the generation of the key-value cache for one layer is completed.

In step S5, the processing device 100 generates the output information for the input information received in step S1. The processing device 100 may acquire the output information output by the machine learning model after the generation of the intermediate data is completed. For example, the processing device 100 may acquire the last token output by the forward processing for the token at the end of the prompt in the prefill phase of the transformer. The processing device 100 transmits the generated output information to the processing device 200.

The output information output in the prefill phase is not limited to text data (tokens). The output information may include at least one of acoustic data or image data. The image data may include a still image and a moving image, and the moving image may include acoustic data. The output information may be multimodal data including at least two of text data, acoustic data, or image data.

In step S6, the processing device 200 receives the output information from the processing device 100. The processing device 200 may store the output information received from the processing device 100 in the memory 220. The processing device 200 may output the output information received from the processing device 100. For example, the processing device 200 may transmit the output information to another device from which the server device 10 has received the input information. For example, the processing device 200 may output the output information to a display device of the server device 10.

In step S7, the processing device 200 generates output information subsequent to the output information received in step S6. The processing device 200 may generate the output information based on the intermediate data received in step S4. The processing device 200 may read the intermediate data stored in the memory 220 and generate the output information based on the read intermediate data. The processing device 200 may generate the output information based on at least a portion of the intermediate data. When the server device 10 includes a plurality of processing devices 200, the processing devices 200 may generate the output information by parallel processing.

The processing device 200 may perform the decode phase of the transformer, for example. The processing device 200 may input the last token generated by the prefill phase into the transformer, for example.

The transformer reads the key-value cache stored in the memory 220 and performs forward processing on the input token. If the transformer generates an embedded representation of the image in step S2, the transformer may read the embedded representation stored in the memory 220 and perform forward processing using the embedded representation. Using the key-value cache, the transformer generates a token subsequent to the input token and a new key-value cache. The transformer outputs a token generated by the forward processing for the input token.

The output information output in the decode phase is not limited to text data (token). The output information may include at least one of acoustic data or image data. The image data may include a still image and a moving image, and the moving image may include acoustic data. The output information may be multimodal data including at least two of text data, acoustic data, or image data.

The processing device 200 acquires the token output by the transformer as the output information. The processing device 200 stores a new key-value cache calculated by the transformer in the memory 220. The processing device 200 may accumulate the key-value caches in the memory 220 until the inference process is completed.

As another example, the processing device 200 may perform the decode phase of the state space model. For example, the processing device 200 may input the last token generated by the prefill phase into the state space model. The state space model reads the state of the state space model stored in the memory 220 and performs forward processing on the input token. The state space model generates a token subsequent to the input token and updates the state of the state space model. The processing device 200 acquires the token output by the state space model as the output information. The processing device 200 overwrites the state stored in the memory 220 with the updated state of the state space model.

As another example, the processing device 200 may perform a decode phase of a machine learning model obtained by combining a transformer and a state space model. In this type of machine learning model, for example, some layers may be formed of the transformer, and other layers may be formed of the state space model. The processing device 200 may input the output information generated by the prefill phase into the machine learning model. In the layers formed of the transformer, the machine learning model performs forward processing using the key-value cache stored in the memory 220, and in the layers formed of the state space model, the machine learning model performs forward processing using the state of the state space model stored in the memory 220. In the layers formed of the transformer, the machine learning model stores a new key-value cache calculated by the transformer in the memory 220, and in the layers formed of the state space model, the machine learning model updates the state of the state space model stored in the memory 220.

The processing device 200 may read at least a portion of the parameters of the machine learning model stored in the memory 220. The processing device 200 may generate the output information based on at least the portion of the parameters read from the memory 220. The processing device 200 may read at least the portion of the parameters of the machine learning model from the memory 220 each time the forward processing for the input token is performed. The processing device 200 may read the portion of the parameters of the machine learning model that are related to the input token from the memory 220.

In step S8, the processing device 200 outputs the output information generated in step S7. The processing device 200 may store the generated output information in the memory 220. For example, the processing device 200 may transmit the output information to another device from which the server device 10 has received the input information. For example, the processing device 200 may output the output information to a display device of the server device 10.

The processing device 200 repeatedly performs the processing of steps S7 and S8 until the generation of the output information of the machine learning model is completed. In step S7 from the second time onward, the processing device 200 may generate next output information by inputting the output information generated in the previous step S7 into the machine learning model. That is, the processing device 200 may generate the output information for the input information in an autoregressive manner.

The processing device 200 may perform a predetermined process using the input information received in step S1. The processing device 200 may receive the input information together with the intermediate data from the processing device 100. The processing device 200 may store the input information received from the processing device 100 in the memory 220. The predetermined process may be forward processing or processing other than the forward processing.

### Other Embodiments

In the above embodiment, a configuration, in which the information processing system 1000 performs the inference process of the machine learning model, has been described. The inference process of the machine learning model may be performed for a training process of the machine learning model.

The information processing system 1000 may perform the inference process as an internal process in the training process of the machine learning model. For example, the information processing system 1000 may perform the inference process of the machine learning model and perform the training process to update the parameters of the machine learning model based on the inference result. Specifically, the information processing system 1000 may perform the training process of repeatedly adjusting the parameters of the machine learning model so that the error between the inference result when training data is input into the machine learning model and ground truth data corresponding to the training data is reduced.

### <Summary>

As will be apparent from the above description, the information processing system 1000 according to the embodiment of the present disclosure includes: at least one first memory; at least one first processor connected to the at least one first memory; at least one second memory; and at least one second processor connected to the at least one second memory. The at least one first processor generates intermediate data by inputting input information into a machine learning model, and transmits at least a portion of the intermediate data to the at least one second memory. The at least one second processor generates output information of the machine learning model, using at least the portion of the intermediate data transmitted by the at least one first processor to the at least one second memory. A ratio of a data transfer speed of the at least one first memory to a computational speed of the at least one first processor is lower than a ratio of a data transfer speed of the at least one second memory to a computational speed of the at least one second processor.

The at least one first memory may store at least a portion of parameters of the machine learning model. The at least one second memory may store at least a portion of parameters of the machine learning model.

The at least one first processor may generate the intermediate data by performing a process in a prefill phase, using the machine learning model. The at least one second processor may generate the output information by performing a process in a decode phase, using the machine learning model.

The machine learning model may include a neural network having an attention mechanism. At least the portion of the intermediate data may include at least a portion of key vectors and value vectors used in the attention mechanism.

The at least one first processor may generate the intermediate data by performing a first process that is compute-bound, using the machine learning model. The at least one second processor may generate the output information by a second process that is memory-bound, using the machine learning model. The first process may be the process in the prefill phase using the machine learning model. The second process may be the process in the decode phase using the machine learning model.

The machine learning model may include a state space model. At least the portion of the intermediate data may include at least a portion of a state in the state space model.

The at least one second processor may repeatedly perform the second process using the output information generated in the previously performed second process. The at least one first processor may start transmitting at least the portion of the intermediate data before the generation of the intermediate data is completed. The at least one first processor may start transmitting at least the portion of the intermediate data after the generation of the intermediate data is completed.

The ratio of the data transfer speed to the computational speed may be a ratio of the total data transfer amount to the total number of operations when the entire process related to the machine learning model is performed. The ratio of the data transfer speed to the computational speed may be a ratio of the data transfer amount per unit time to the number of operations per unit time when the process related to the machine learning model is performed.

The information processing system 1000 may include a plurality of second memories and a plurality of second processors. The at least one first processor may transmit at least the portion of the intermediate data to each of the plurality of second memories. The plurality of second processors may form a cluster.

The information processing system 1000 may include a plurality of first memories and a plurality of first processors. The plurality of first processors may combine at least the portion of the intermediate data generated by each of the plurality of first processors and transmit the combined data to the at least one second memory.

The information processing system 1000 may perform an inference process of the machine learning model. The information processing system 1000 may perform an inference process for a training process of the machine learning model.

The information processing system 1000 may include a first processing device including at least one first memory and at least one first processor connected to the at least one first memory. The information processing system 1000 may include a second processing device including at least one second memory and at least one second processor connected to the at least one second memory.

With this, according to the embodiment of the present disclosure, the first processor having a high computational performance performs the generation of the intermediate data, which is compute-bound, and the second processor having a large memory bandwidth performs the generation of the output information, which is memory-bound, thereby calculating the output information of the machine learning model at high speed.

### Hardware Configuration

Some or all of the devices (the server devices 10 and 20) in the above-described embodiments may be configured by hardware or may be configured by information processing of software (program) executed by a central processing unit (CPU), a graphics processing unit (GPU), or the like. In the case where the embodiment is configured by the information processing of software, software for realizing at least some of the functions of the devices in the above-described embodiments may be stored in a non-transitory storage medium (a non-transitory computer-readable medium), such as a compact disc-read only memory (CD-ROM) or a universal serial bus (USB) memory, and a computer may read the software to perform the information processing of the software. Additionally, the software may be downloaded via a communication network. Furthermore, all or some of the processes of software may be implemented in a circuit, such as an application specific integrated circuit (ASIC) or a field programmable gate array (FPGA), and the information processing by the software may be executed by hardware.

The storage medium storing the software may be a removable medium, such as an optical disk, or a fixed storage medium, such as a hard disk or a memory. Additionally, the storage medium may be provided inside the computer (a main storage device, an auxiliary storage device, or the like) or may be provided outside the computer.

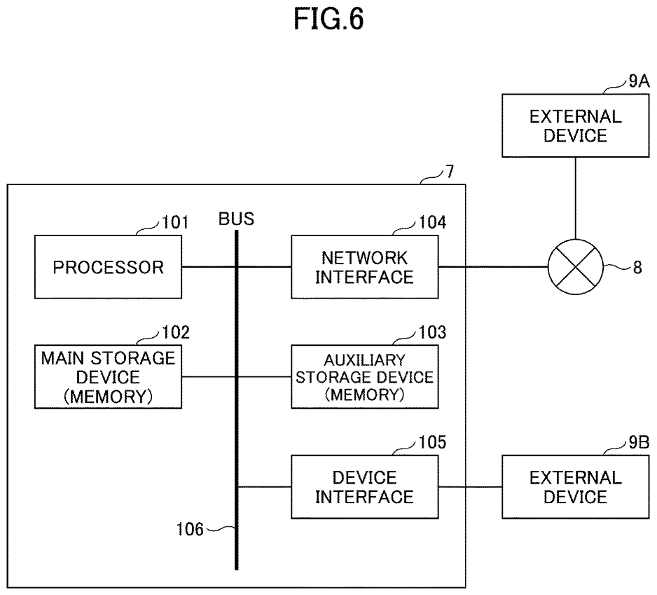

FIG. 6 is a block diagram illustrating an example of a hardware configuration of the devices (the server devices 10 and 20) in the above-described embodiments. Each of the devices may be implemented as a computer 7 including a processor 101, a main storage device 102 (memory), an auxiliary storage device 103 (memory), a network interface 104, and a device interface 105, which are connected via a bus 106, for example.

The computer 7 of FIG. 6 includes one of each component, but may include multiple units of the same components. Additionally, although FIG. 6 illustrates one computer 7, the software may be installed in multiple computers, and the multiple computers may execute the same or different partial processes of the software. In this case, the computers may be in a distributed computing form in which the computers communicate with each other via the network interface 104 or the like to perform the processes. That is, the devices (the server devices 10 and 20) in the above-described embodiments may be configured as a system that realizes a function by one or more computers executing instructions stored in one or more storage devices. Additionally, the devices may be configured such that information transmitted from a terminal may be processed by one or more computers provided on a cloud, and the processing result may be transmitted to the terminal.

The various operations of the devices (the server devices 10 and 20) in the above-described embodiments may be performed by parallel processing using one or more processors or using multiple computers connected via a network. Additionally, various operations may be distributed to multiple operation cores in the processor and performed by parallel processing. Additionally, some or all of the processes, means, and the like of the present disclosure may be implemented by at least one of a processor or a storage device provided on a cloud that can communicate with the computer 7 via a network. As described above, each of the devices in the above-described embodiments may be in a form of parallel computing by one or more computers.

The processor 101 may be an electronic circuit (a processing circuit, processing circuitry, a CPU, a GPU, an FPGA, an ASIC, or the like) that performs at least one of control or operations of a computer. Additionally, the processor 101 may be any of a general-purpose processor, a dedicated processing circuit designed to execute a specific operation, or a semiconductor device including both the general-purpose processor and the dedicated processing circuit. Additionally, the processor 101 may include an optical circuit or may include an arithmetic function based on quantum computing.

The processor 101 may perform arithmetic processing based on data or software input from each device or the like of the internal configuration of the computer 7, and may output an arithmetic result or a control signal to each device or the like. The processor 101 may control each component constituting the computer 7 by executing an operating system (OS), an application, or the like of the computer 7.

The devices (the server devices 10 and 20) in the above-described embodiments may be implemented by one or more processors 101. Here, the processor 101 may refer to one or more electronic circuits disposed on one chip, or may refer to one or more electronic circuits disposed on two or more chips or two or more devices. When multiple electronic circuits are used, the electronic circuits may communicate with each other by wire or wirelessly.

The main storage device 102 may store instructions executed by the processor 101, various data, and the like, and information stored in the main storage device 102 may be read by the processor 101. The auxiliary storage device 103 is a storage device other than the main storage device 102. Here, these storage devices indicate any electronic components capable of storing electronic information, and may be semiconductor memories. The semiconductor memory may be either a volatile memory or a nonvolatile memory. The storage device for storing various data and the like in the device in the above-described embodiments (the server devices 10 and 20) may be realized by the main storage device 102 or the auxiliary storage device 103, or may be realized by a built-in memory built in the processor 101. For example, the storage devices in the above-described embodiments may be realized by the main storage device 102 or the auxiliary storage device 103.

When the device in the above-described embodiments (the server devices 10 and 20) includes at least one storage device (memory) and at least one processor connected (coupled) to the at least one storage device, the at least one processor may be connected to one storage device. Additionally, at least one storage device may be connected to one processor. Additionally, a configuration in which at least one processor among the multiple processors is connected to at least one storage device among the multiple storage devices may be included. Additionally, this configuration may be realized by storage devices and the processors included in multiple computers. Furthermore, a configuration in which the storage device is integrated with the processor (for example, an L1 cache or a cache memory including an L2 cache) may be included.

The network interface 104 is an interface for connecting to a communication network 8 by wire or wirelessly. As the network interface 104, an appropriate interface, such as one conforming to an existing communication standard, may be used. The network interface 104 may exchange information with an external device 9A connected via the communication network 8. Here, the communication network 8 may be any one of a wide area network (WAN), a local area network (LAN), a personal area network (PAN), and the like, or a combination thereof, as long as information is exchanged between the computer 7 and the external device 9A. Examples of the WAN include the Internet and the like, and examples of the LAN include IEEE802.11, Ethernet (registered trademark), and the like. Examples of the PAN include Bluetooth (registered trademark), Near Field Communication (NFC), and the like.

The device interface 105 is an interface, such as a USB, that is directly connected to an external device 9B.

The external device 9A is a device connected to the computer 7 via a network. The external device 9B is a device directly connected to the computer 7.

The external device 9A or the external device 9B may be, for example, an input device. The input device is, for example, a device, such as a camera, a microphone, a motion capture device, various sensors, a keyboard, a mouse, a touch panel, or the like, and gives acquired information to the computer 7. Alternatively, the device may be a device including an input unit, a memory, and a processor, such as a personal computer, a tablet terminal, or a smartphone.

Additionally, the external device 9A or the external device 9B may be, for example, an output device. The output device may be, for example, a display device, such as a liquid crystal display (LCD) or an organic electro luminescence (EL) panel, or may be a speaker that outputs sound or the like. Alternatively, the device may be a device including an output unit, a memory, and a processor, such as a personal computer, a tablet terminal, or a smartphone.

Additionally, the external device 9A or the external device 9B may be a storage device (a memory). For example, the external device 9A may be a network storage or the like, and the external device 9B may be a storage, such as a hard disk drive (HDD).

Additionally, the external device 9A or the external device 9B may be a device having a function of a part of the components of the device in the above-described embodiments (the server devices 10 and 20). That is, the computer 7 may transmit a part or all of the processing result to the external device 9A or the external device 9B, or may receive a part or all of the processing result from the external device 9A or the external device 9B.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a process A and the one or more hardware perform a process B” is used, the hardware that performs the process A may be the same as or different from the hardware that performs the process B. That is, the hardware that performs the process A and the hardware that performs the process B may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

In the present specification (including the claims), the terms “first,” “second,” and the like are used as a method of merely distinguishing between two or more elements and are not necessarily intended to impose technical significance on their objects, in a temporal manner, in a spatial manner, in order, in quantity, or the like. Therefore, for example, a reference to first and second elements does not necessarily indicate that only two elements can be employed there, that the first element must precede the second element, that the first element must be present in order for the second element to be present, or the like.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

In the disclosed technique, aspects such as those described in the following clauses are conceivable.

### (Clause 1)

An information processing system including:
at least one first memory;
at least one first processor connected to the at least one first memory;
at least one second memory; and
at least one second processor connected to the at least one second memory;
wherein the at least one first processor is configured to:
generate intermediate data by inputting input information into a machine learning model; and
transmit at least a portion of the intermediate data to the at least one second memory,
wherein the at least one second processor is configured to generate output information of the machine learning model, using at least a portion of the intermediate data transmitted by the at least one first processor to the at least one second memory, and
wherein a ratio of a data transfer speed of the at least one first memory to a computational speed of the at least one first processor is lower than a ratio of a data transfer speed of the at least one second memory to a computational speed of the at least one second processor.

### (Clause 2)

The information processing system as described in Clause 1,
wherein the at least one first memory stores at least a portion of parameters of the machine learning model, and
wherein the at least one second memory stores at least a portion of the parameters of the machine learning model.

### (Clause 3)

The information processing system as described in Clause 1 or 2, wherein the at least one first processor is configured to generate the intermediate data by performing a process in a prefill phase, using the machine learning model, and
wherein the at least one second processor is configured to generate the output information by performing a process in a decode phase, using the machine learning model.

### (Clause 4)

The information processing system as described in Clause 3, wherein the machine learning model includes a neural network having an attention mechanism.

### (Clause 5)

The information processing system as described in Clause 4, wherein at least the portion of the intermediate data includes at least a portion of key vectors and value vectors used in the attention mechanism.

### (Clause 6)

The information processing system as described in any one of Clauses 1 to 5,
wherein the at least one first processor is configured to generate the intermediate data by performing a first process that is compute-bound, using the machine learning model, and
wherein the at least one second processor is configured to generate the output information by performing a second process that is memory-bound, using the machine learning model.

### (Clause 7)

The information processing system as described in Clause 6,
wherein the first process is a process in a prefill phase using the machine learning model, and
wherein the second process is a process in a decode phase using the machine learning model.

### (Clause 8)

The information processing system as described in Clause 6, wherein the machine learning model includes a state space model.

### (Clause 9)

The information processing system as described in Clause 8, wherein at least the portion of the intermediate data includes at least a portion of a state in the state space model.

### (Clause 10)

The information processing system as described in any one of Clauses 6 to 9, wherein the at least one second processor is configured to repeatedly perform the second process, using the output information generated in the second process performed previously.

### (Clause 11)

The information processing system described in any one of Clauses 1 to 10, wherein the at least one first processor is configured to start transmitting at least a portion of the intermediate data before generation of the intermediate data is completed.

### (Clause 12)

The information processing system described in any one of Clauses 1 to 11, wherein the at least one first processor is configured to start transmitting at least a portion of the intermediate data after generation of the intermediate data is completed.

### (Clause 13)

The information processing system as described in any one of Clauses 1 to 12, wherein the ratio of the data transfer speed to the computational speed is a ratio of a total data transfer amount to a total number of operations when an entire process related to the machine learning model is performed.

### (Clause 14)

The information processing system as described in any one of Clauses 1 to 13, wherein the ratio of the data transfer speed to the computational speed is a ratio of a data transfer amount per unit time to a number of operations per unit time when a process related to the machine learning model is performed.

### (Clause 15)

The information processing system as described in any one of Clauses 1 to 14, including:
a plurality of second memories; and
a plurality of second processors,
wherein the at least one first processor is configured to transmit at least the portion of the intermediate data to each of the plurality of second memories.

### (Clause 16)

The information processing system as described in Clause 15, wherein the plurality of second processors form a cluster.

### (Clause 17)

The information processing system as described in any one of Clauses 1 to 16, comprising:
a plurality of first memories; and
a plurality of first processors,
wherein the plurality of first processors are configured to combine at least portions of a plurality of pieces of intermediate data and transmit the combined intermediate data to the at least one second memory, each of the plurality of pieces of intermediate data being generated by a corresponding first processor of the plurality of first processors.

### (Clause 18)

The information processing system as described in any one of Clauses 1 to 17, wherein the information processing system is configured to perform an inference process of the machine learning model.

### (Clause 19)

The information processing system as described in Clause 18, wherein the information processing system is configured to perform the inference process for a training process of the machine learning model.

### (Clause 20)

The information processing system as described in any one of Clauses 1 to 19, including:
a first processing device including:
   the at least one first memory; and
   the at least one first processor connected to the at least one first memory; and a second processing device including: the at least one second memory; and the at least one second processor connected to the at least one second memory.

### (Clause 21)

An information processing method including:

generating, by at least one first processor connected to at least one first memory, intermediate data by inputting input information into a machine learning model;
transmitting, by the at least one first processor connected to the at least one first memory, at least a portion of the intermediate data to the at least one second memory; and
generating, by at least one second processor connected to at least one second memory, output information of the machine learning model, using at least a portion of the intermediate data transmitted by the at least one first processor to the at least one second memory,
wherein a ratio of a data transfer speed of the at least one first memory to a computational speed of the at least one first processor is lower than a ratio of a data transfer speed of the at least one second memory to a computational speed of the at least one second processor.

### (Clause 22)

One or more programs for causing at least one first processor connected to at least one first memory to generate intermediate data by inputting input information into a machine learning model and transmit at least a portion of the intermediate data to the at least one second memory, and causing at least one second processor connected to at least one second memory to generate output information of the machine learning model, using at least a portion of the intermediate data transmitted by the at least one first processor to the at least one second memory,
wherein a ratio of a data transfer speed of the at least one first memory to a computational speed of the at least one first processor is lower than a ratio of a data transfer speed of the at least one second memory to a computational speed of the at least one second processor.

What is claimed is:

1. An information processing system comprising:
at least one first memory;
at least one first processor connected to the at least one first memory;
at least one second memory; and
at least one second processor connected to the at least one second memory;
wherein the at least one first processor is configured to generate intermediate data by inputting input information into a machine learning model,
wherein the at least one second processor is configured to generate output information of the machine learning model, using at least a portion of the intermediate data generated by the at least one first processor,
wherein a ratio of a data transfer speed of the at least one first memory to a computational speed of the at least one first processor is lower than a ratio of a data transfer speed of the at least one second memory to a computational speed of the at least one second processor, and
wherein the at least one first processor and the at least one second processor are different types of processors.

2. The information processing system as claimed in claim 1,
wherein the at least one first memory stores at least a portion of parameters of the machine learning model, and
wherein the at least one second memory stores at least a portion of the parameters of the machine learning model.

3. The information processing system as claimed in claim 1,
wherein the at least one first processor is configured to generate the intermediate data by performing a process in a prefill phase, using the machine learning model, and
wherein the at least one second processor is configured to generate the output information by performing a process in a decode phase, using the machine learning model.

4. The information processing system as claimed in claim 3, wherein the machine learning model includes a neural network having an attention mechanism.

5. The information processing system as claimed in claim 4, wherein at least the portion of the intermediate data includes at least a portion of key vectors and value vectors used in the attention mechanism.

6. The information processing system as claimed in claim 5, wherein the at least one first processor is configured to transmit the key vectors and the value vectors, generated on a layer-by-layer basis, to the at least one second memory on a layer-by-layer basis.

7. The information processing system as claimed in claim 1,
wherein the at least one first processor is configured to generate the intermediate data by performing a first process, using the machine learning model, and
wherein the at least one second processor is configured to generate the output information by performing a second process, using the machine learning model.

8. The information processing system as claimed in claim 7,
wherein the first process is compute-bound, and
wherein the second process is memory-bound.

9. The information processing system as claimed in claim 7, wherein the machine learning model includes a state space model.

10. The information processing system as claimed in claim 7, wherein the at least one second processor is configured to repeatedly perform the second process, using the output information generated in the second process performed previously.

11. The information processing system as claimed in claim 1, wherein the ratio of the data transfer speed to the computational speed is a ratio of a total data transfer amount to a total number of operations when an entire process related to the machine learning model is performed.

12. The information processing system as claimed in claim 1, wherein the ratio of the data transfer speed to the computational speed is a ratio of a data transfer amount per unit time to a number of operations per unit time when a process related to the machine learning model is performed.

13. The information processing system as claimed in claim 1, wherein the at least one second memory includes a three-dimensionally structured memory including stacked layers.

14. The information processing system as claimed in claim 1,
wherein the at least one second memory includes a plurality of second memories, and the at least one second processor includes a plurality of second processors, and
wherein each of the plurality of second processors is configured to generate output information of the machine learning model, using at least a portion of the intermediate data generated by the at least one first processor.

15. The information processing system as claimed in claim 14, wherein the plurality of second processors form a cluster.

16. The information processing system as claimed in claim 1,
wherein the at least one first memory includes a plurality of first memories, and the at least one first processor includes a plurality of first processors, and
wherein the plurality of first processors are configured to combine at least portions of a plurality of pieces of intermediate data and transmit the combined intermediate data to the at least one second memory, each of the plurality of pieces of intermediate data being generated by a corresponding first processor of the plurality of first processors.

17. The information processing system as claimed in claim 1, comprising:
a first processing device including:
the at least one first memory; and
the at least one first processor connected to the at least one first memory; and
a second processing device including:
the at least one second memory; and
the at least one second processor connected to the at least one second memory,
wherein the first processing device and the second processing device are different types of processing devices.

18. The information processing system as claimed in claim 17, wherein the first processing device is configured to start transmitting at least a portion of the intermediate data to the second processing device before generation of the intermediate data is completed.

19. The information processing system as claimed in claim 17,
wherein the first processing device is a first GPU package, and
wherein the second processing device is a second GPU package.

20. The information processing system as claimed in claim 17,
wherein the first processing device is a first type of accelerator, and
wherein the second processing device is a second type of accelerator.

21. The information processing system as claimed in claim 17, wherein the first processing device and the second processing device are connected via an interconnect.

22. The information processing system as claimed in claim 17, comprising a plurality of first processing devices including the first processing device and a plurality of second processing devices including the second processing device.

23. The information processing system as claimed in claim 22, wherein a number of the plurality of first processing devices is equal to a number of the plurality of second processing devices.

24. The information processing system as claimed in claim 1, forming a cluster.

25. An information processing method comprising:
generating, by at least one first processor connected to at least one first memory, intermediate data by inputting input information into a machine learning model; and
generating, by at least one second processor connected to at least one second memory, output information of the machine learning model, using at least a portion of the intermediate data generated by the at least one first processor,
wherein a ratio of a data transfer speed of the at least one first memory to a computational speed of the at least one first processor is lower than a ratio of a data transfer speed of the at least one second memory to a computational speed of the at least one second processor, and
wherein the at least one first processor and the at least one second processor are different types of processors.

26. The information processing method as claimed in claim 25,
wherein the generating of the intermediate data includes generating, by the at least one first processor, the intermediate data by performing a process in a prefill phase, using the machine learning model, and
wherein the generating of the output information includes generating, by the at least one second processor, the output information by performing a process in a decode phase, using the machine learning model.

27. The information processing method as claimed in claim 26, wherein the machine learning model includes a neural network having an attention mechanism.

28. The information processing method as claimed in claim 27, wherein at least the portion of the intermediate data includes at least a portion of key vectors and value vectors used in the attention mechanism.

29. The information processing method as claimed in claim 28, comprising transmitting, by the at least one first processor, the key vectors and the value vectors, generated on a layer-by-layer basis, to the at least one second memory on a layer-by-layer basis.

30. The information processing method as claimed in claim 25,
wherein the generating of the intermediate data includes generating, by the at least one first processor, the intermediate data by performing a first process, using the machine learning model, and
wherein the generating of the output information includes generating, by the at least one second processor, the output information by performing a second process, using the machine learning model.

31. The information processing method as claimed in claim 30,
wherein the first process is compute-bound, and
wherein the second process is memory-bound.

32. The information processing method as claimed in claim 30, wherein the performing of the second process includes repeatedly performing, by the at least one second processor, the second process, using the output information generated in the second process performed previously.

33. The information processing method as claimed in claim 25,
wherein the at least one second processor includes a plurality of second processors, and
wherein the information processing method comprises generating, by each of the plurality of second processors, output information of the machine learning model, using at least a portion of the intermediate data generated by the at least one first processor.

34. The information processing method as claimed in claim 25,
wherein the at least one first processor includes a plurality of first processors, and
wherein the information processing method comprises combining at least portions of a plurality of pieces of intermediate data and transmitting the combined intermediate data to the at least one second memory, by the plurality of first processors, each of the plurality of pieces of intermediate data being generated by a corresponding first processor of the plurality of first processors.

35. The information processing method as claimed in claim 25,
wherein a first processing device includes:
the at least one first memory; and
the at least one first processor connected to the at least one first memory; and
a second processing device includes:
the at least one second memory; and
the at least one second processor connected to the at least one second memory, and
wherein the information processing method comprises starting, by the first processing device, transmitting at least a portion of the intermediate data to the second processing device before generation of the intermediate data is completed.

36. A non-transitory computer-readable storage medium having stored therein one or more programs for causing at least one first processor connected to at least one first memory to generate intermediate data by inputting input information into a machine learning model and causing at least one second processor connected to at least one second memory to generate output information of the machine learning model, using at least a portion of the intermediate data generated by the at least one first processor,
wherein a ratio of a data transfer speed of the at least one first memory to a computational speed of the at least one first processor is lower than a ratio of a data transfer speed of the at least one second memory to a computational speed of the at least one second processor, and
wherein the at least one first processor and the at least one second processor are different types of processors.
